(19) United States
(12) Patent Application Publication
(10) Pub. No.: US 2002/0161883 A1
(43) Pub. Date: Oct. 31, 2002

(54) System and method for collecting, aggregating, and coalescing network discovery data

(76) Inventors: David Matheny, South Jordan, UT (US); Dale Taylor, Lindon, UT (US); Richard R. Winterton, Provo, UT (US)

Correspondence Address: FISH & RICHARDSON, PC, 4350 LA JOLLA VILLAGE DRIVE, SUITE 500, SAN DIEGO, CA, 92122, US

(21) Appl. No.: 09/846,521

(22) Filed: Apr. 30, 2001

(51) Int. Cl. G06F 15/173

(52) U.S. Cl. 709/224; 709/223

(57) ABSTRACT

In an embodiment, a network management system is capable of performing a coordinated discovery operation on devices in a network using a number of discovery and aggregator agents. Data collected and generated by the agents may be coalesced into a database file. New agents may be added to the system as plug-ins by registering an XML file with a network manager.

### BACKGROUND

Managers of computer networks may use a variety of network management tools to manage a network. These tools may be used to determine the operational status of equipment and transmission facilities and to obtain notification of faults and threshold conditions, e.g., network traffic bottlenecks. Such tools enable network managers to better manage large and complex networks and facilitate configuration changes.

One type of network management tool is the discovery agent. These agents gather information from devices in the network. This information may be used to evaluate network performance and possible faults, as well provide information needed to reconfigure the network. A network manager may wish to incorporate new discovery agents into its existing set as they become available or as the network expands and evolves. Also, as new network devices are created and incorporated into the network, new ways to discover the new devices may be necessary. However, incorporating the new agents into the network management system may require reconfiguration and modification of the new agent and/or the system. Furthermore, the new agents may gather information already provided by existing agents, thereby generating redundant data that adds to the complexity of processing the discovery information.

### BRIEF DESCRIPTION OF THE DRAWINGS

FIG. 1 is a block diagram of a network management system according to an embodiment.

FIG. 2 is a flowchart illustrating a registration operation according to an embodiment.

FIG. 3 is a flowchart illustrating a discovery operation according to an embodiment.

FIG. 4 is a flowchart illustrating an aggregation operation according to an embodiment.

FIG. 5 is a flowchart illustrating a coalescing operation according to an embodiment.

### DETAILED DESCRIPTION

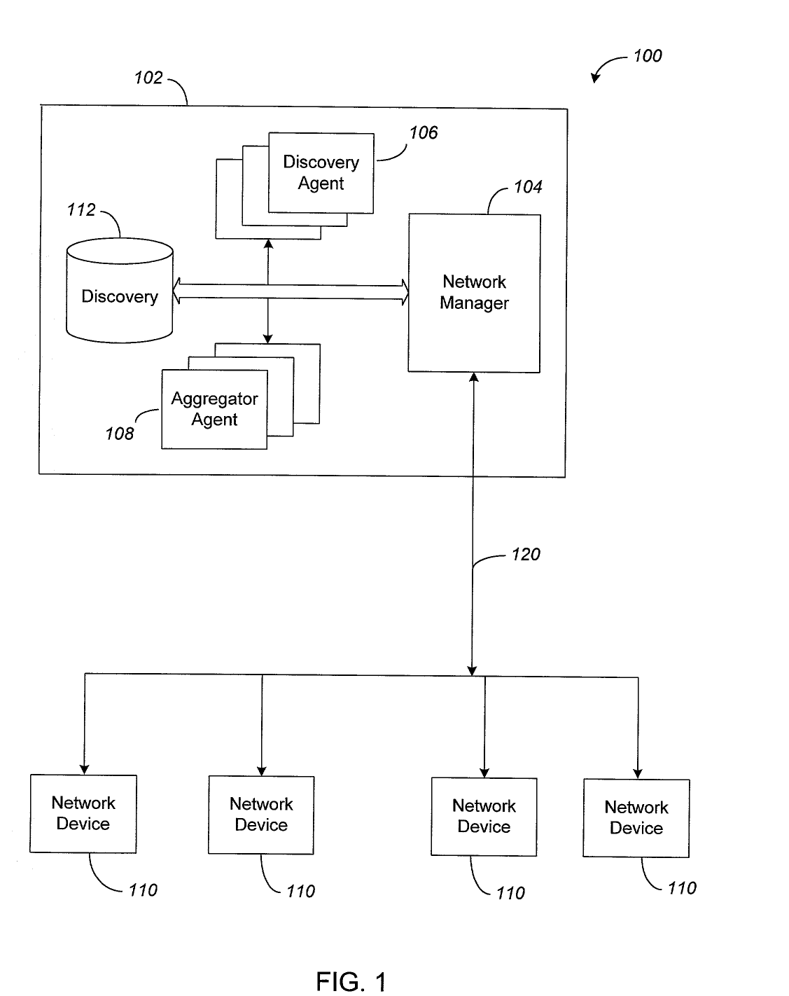

A networked computer system (“network”) 100, as shown in FIG. 1, includes a network management system 102 capable of performing a coordinated network discovery operation using a number of discovery agents according to an embodiment. The network management system 102 includes a network manager 104, which utilizes a number of different network discovery agents 106 and aggregator agents 108 to perform discovery operations. The network management system 102 accommodates the incorporation of new discovery agents and aggregator agents into the system over time.

The network 100 includes a variety of interconnected network devices 110, which may include, for example, network servers, as well as workstations, file servers, web servers, hubs, routers, etc., and software objects on such machines. The network 100 may be organized as a Local Area Network (LAN), Wide Area Network (WAN), intranet, etc., and may include a number of smaller subnets. The network may operate over a variety of communications media 120, e.g., twisted pair cable, coaxial cable, fiber optic cable, wireless transceiver links, etc., and communication protocols, e.g., Transmission Control Protocol/Internet Protocol (TCP/IP), Ethernet, Synchronous Optical Network (SONET), etc.

The network manager 104 may be a host computer that includes software for initiating and coordinating network discovery operations on devices in the network using a number of different agents. More than one network manager may be allocated to the network 100.

The discovery agents 106 collect information from targeted network devices 110 during a discovery operation (described below), for example, by polling devices in a certain range of addresses or in a particular subnet. Different discovery agents may perform discovery operations using different techniques, and may collect different types of data. Discovery agents may be on the same computer as the discovery manager, or may reside on a remote machine that uses a local module to communicate with the discovery manager. The discovery agents used in the system may use a number of different management protocols including, for example, Simple Network Management Protocol (SNMP), Remote Monitoring (RMON), Internet Control Message Protocol (ICMP), and other existing standardized and propriety management protocols, as well as management protocols that may become available in the future. Compliant devices may have a corresponding agent. For example, SNMP-compliant device include an SNMP agent.

SNMP (documented in the Institute of Electrical and Electronics Engineers, Inc., (IEEE) Request for Comments (RFC) 1098, April 1989) is an application-level protocol that is part of the TCP/IP protocol suite. An SNMP discovery agent sends messages, called protocol data units (PDUs), to different parts of the network. SNMP-complaint devices store data about themselves in Management Information Bases (MIBs) and return this data to the SNMP requester. The MIBs may include low-level attributes (variables) of the configuration or operation of the managed device.

RMON (documented in IEEE RFC 1757, February 1995) is another management protocol. Unlike SNMP, RMON defines a number of different MIB types, and therefore may return a more detailed set of data than an SNMP discovery agent.

ICMP (documented in IEEE RFC 792, September 1981), an extension of the Internet Protocol (IP), supports packets containing error, control, and information message. The Packet Internet Groper (PING) is an ICMP utility, which is used to test an Internet connection. PING tests the connection by sending a single data packet and listening for a single packet in reply from an ICMP-compliant device.

Aggregator agents 108 process the data collected by the discovery agents to generate additional information that may be useful to the network manager 104. This additional information may include higher-level attributes about a device that are computed from the data collected by a discovery agent, e.g., MIB variables. Aggregator agents may have certain dependencies that must be fulfilled before they are called in order to generate useful information. For example, some aggregator agents may only operate on certain variables. Also, some aggregator agents may only operate on data collected by a particular discovery agent or set of agents.

In an embodiment, the Extensible Markup Language (XML) may be used as the communication language between agents and the discovery manager during the discovery operation. When the different components communicate, they do so by passing XML files to each other. Although XML is described, other standard markup languages that accommodate customized tags for different attributes may be used, for example, the Standard Generalized Markup Language (SGML).

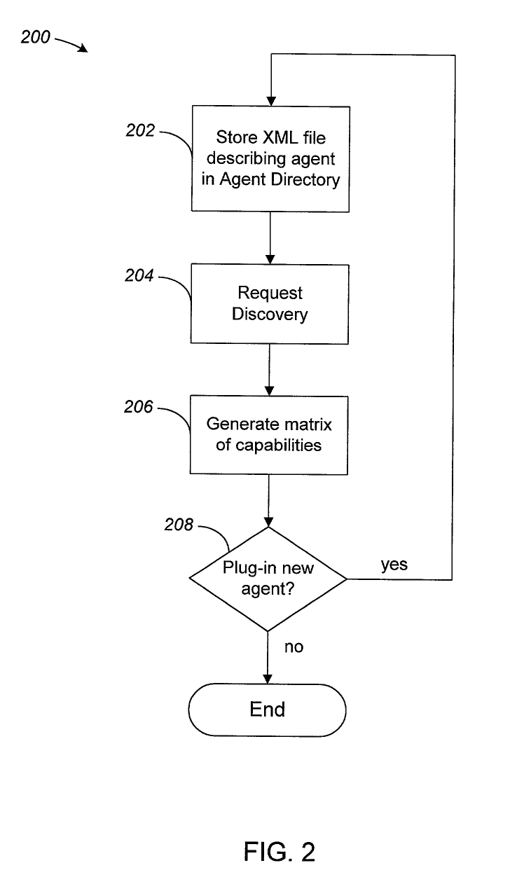

FIG. 2 is a flowchart that describes a registration operation 200 according to an embodiment. An agent registers with the discovery manager by placing an XML file in an agent directory in the discovery database 112 (block 202). The registration file includes tags describing the attributes of the agent, calls that the agent supports, and any requirements the agent has, including dependencies. Each time a discovery operation 300 (described below) is requested, the network manager 104 reads through the agent directory and generates a matrix of available capabilities and existing dependencies (block 206) by parsing the registration files of the various agents.

Agents may be registered during installation or during an upgrade. The network system may be upgraded by adding new agents as “plug-ins” (block 208). The registration operation for the plug-in agents may be performed on the fly, without modifying the existing agents or discovery methodology. As plug-ins, the agents may be called as executables or loadable modules.

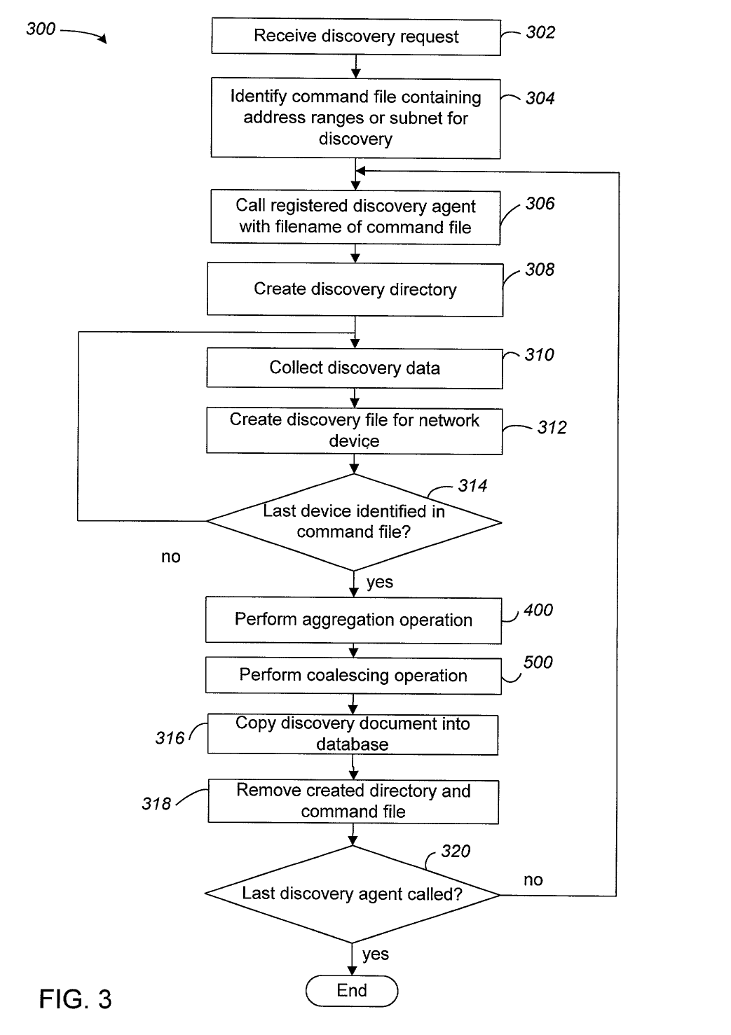

FIG. 3 is a flowchart that describes a discovery operation 300 according to an embodiment. The discovery operation 300 is initiated by the network manager 104 receiving a discovery request (block 302). The discovery request may include requested data types and designate an address range(s) or subnet(s) for discovery. The discovery request may be compared to the available capabilities defined by the matrix derived from the registration files in the agent directory. The network manager 104 loops through files in a command directory, searching for XML files that match the address ranges or subnets identified for discovery (block 304). These files may include a high-level tag named <task> for easy recognition. The network manager may then create a command file for each identified discovery agent.

As each file is found, a registered discovery agent may be called with the full path and filename of the file as a parameter (block 306). When the discovery agent begins to run, it may create a discovery directory in the same folder that contains the command file using a request identifier in the command file (block 308). For example, if the command file is “/somepath/command/cmd.xml” with a <requestid> tag with the value “1234567”, the discovery agent creates the directory “/somepath/command/1234567”.

The discovery agent 106 collects data from each device that it discovers (block 310), and places the collected data in a file created for that device in the discovery directory (block 312). The discovery agent may name the files in such a way as to avoid duplicates, for example, by using the device's IP address as a filename. Each file may be generated as a valid XML file with a tag line followed by the tag <node>. The terminating </node> may be omitted in order to enable aggregator agents, called later in the operation 300, to append to the file.

The discovery agent may also create a relationship file, which indicates how the discovered nodes relate to each other. This file may be named using the request identifier from the original command file. In the example above, a relationship file may have the name “/somepath/command/1234567/1234567.xml”.

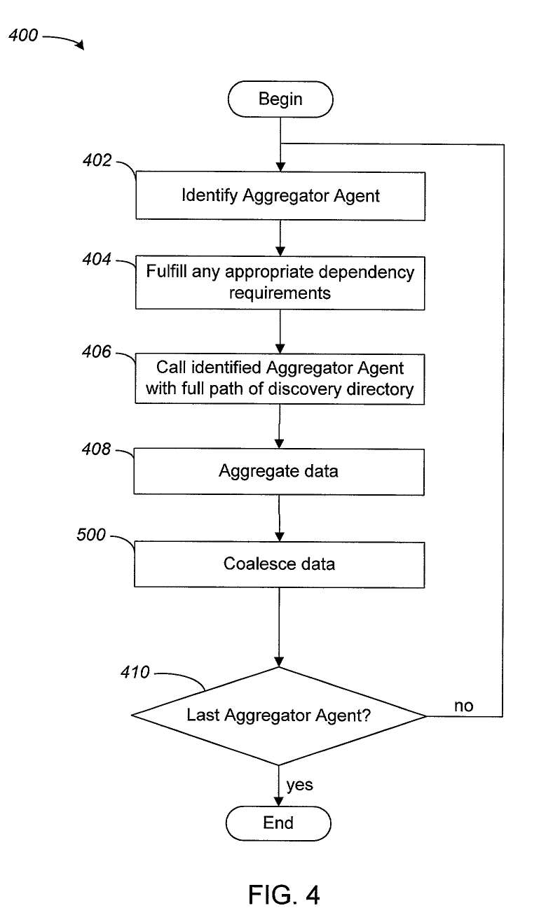

When the discovery agent completes collecting data from all available devices in the designated address range or subnet (block 314), an aggregator operation 400 according to an embodiment is performed. As shown in FIG. 4, the network manager 104 identifies a registered aggregator agent (block 402) and fulfills any dependencies (block 404) before calling the aggregator agent. The aggregator agents may be called with the full path of the discovery directory created by the discovery agent (block 406) and aggregate the data in the files (block 408).

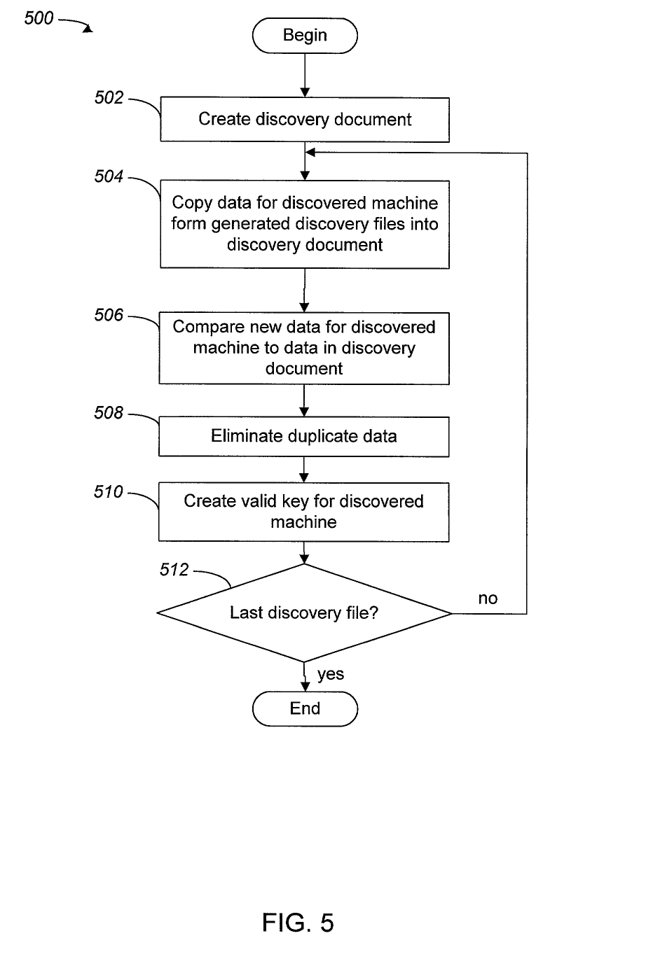

FIG. 5 is a flowchart describing a coalescing operation 500 according to an embodiment. After the first aggregator agent completes, the network manager 104 may create a discovery document and begin to coalesce the discovered and aggregated information (block 502). The discovery document may be created with a top-level node named, for example, <i-discover>. The network manager 104 loops through the information in all of the discovery files for the discovered devices generated and appended by the various discovery and aggregator agents and copies the data into the discovery document (block 504).

In the process of copying the data, new data may be compared to previously copied data (block 506) and any duplicate data may be eliminated (408). The same device may be discovered multiple times, by different discovery agents. As described above, files corresponding to a particular device may have the same name, e.g., the IP address. Identical information for the same device, as identified by the file name, may be eliminated.

The network manager 104 may create a valid key for each discovered device (block 510). The network manager may generate the key by parsing a special precedence file that contains specific instructions for defining a valid node for generating the key. After data from all of the discovery files has been coalesced, this precedence file may also be appended to the discovery document.

After the first aggregator agent 108 completes, the network manager 104 loops through the other aggregator agents, repeating the aggregator operation until all registered aggregator agents have been called.

After the aggregator operation 400 has been performed on all files in the discovery directory created by the last-called discovery agent 106, the discovery document may be copied to the discovery database (block 316), and the discovery directory and command files generated for the discovery operation 300 removed (block 318). The network manager 104 continues to loop through the other discovery agents 106 (block 320), repeating the operation (blocks 306-318) until all registered discovery agents have been called and all discovered and aggregated information has been coalesced into the discovery document.

In an embodiment, discovery agents 106 may be given different priorities based on the accuracy of the data they collect. For example, SNMP may be assigned a higher priority than PING. SNMP and PING may both return the same data from a discovered device, e.g., the hostname. In the event of a discrepancy during the coalescing operation, the data collected by the agent with the higher priority (SNMP) would be copied into the discovery document, and the data collected by the lower priority agent (PING) discarded.

A number of embodiments have been described. Nevertheless, it will be understood that various modifications may be made without departing from the spirit and scope of the invention. For example, steps of the various operations may be performed in a different order and still achieve desirable results. Accordingly, other embodiments are within the scope of the following claims.

1. A method comprising:
receiving discovery data collected from a network device by two or more discovery agents;
aggregating said discovery data;
coalescing the discovery data in a discovery document, said discovery data including two or more duplicate data entries; and
removing all but one of the duplicate data entries from the discovery document.

2. The method of claim 1, further comprising registering agents in an agent directory.

3. The method of claim 2, wherein said receiving discovery data comprises calling said two or more discovery agents from the agent directory.

4. The method of claim 2, wherein said aggregating said data comprises calling two or more aggregator agents listed in an agent directory.

5. The method of claim 2, wherein the agent directory comprises a plurality of Extensible Markup Language (XML) files.

6. The method of claim 1, wherein said removing all but one of the duplicate data entries comprises:
identifying two or more agents responsible for generating the two or more duplicate data entries, each agent having a priority value;
comparing the priority values of the two or more agents;
identifying a first agent having a highest priority, said first agent responsible for generating a first duplicate data entry in the two or more duplicate data entries; and
removing all but the first duplicate date entry.

7. The method of claim 6, wherein the two or more agents are discovery agents.

8. The method of claim 6, wherein the two or more agents are aggregator agents.

9. The method of claim 1, wherein the discovery document is an Extensible Markup Language (XML) file.

10. The method of claim 1, wherein said receiving discovery data comprises receiving discovery data collected from two or more network device by said two or more discovery agents.

11. The method of claim 10, further comprising:
storing the discovery document in a discovery database; and
generating a key for each discovered network device in the discovery document.

12. A method comprising:
registering a first plurality of agents;
performing a first discovery operation including
collecting and aggregating data from a first plurality of network devices with said first plurality of agents, and
coalescing said data in a discovery document;
registering an additional agent; and
performing a second discovery operation with a second plurality of agents including said first plurality of agents and said additional agent.

13. The method of claim 12, wherein said first plurality of agents include a plurality of discovery agents and a plurality of aggregator agents.

14. The method of claim 12, wherein said registering the additional agent comprises storing an agent file describing attributes of the additional agent in an agent directory.

15. The method of claim 14, wherein the agent file comprises an Extensible Markup Language (XML) file.

16. An article, including instructions residing on a machine-readable medium, the instructions causing a machine to:
receive discovery data collected from a network device by two or more discovery agents;
aggregate said discovery data;
coalesce the discovery data in a discovery document, said discovery data including two or more duplicate data entries; and
remove all but one of the duplicate data entries from the discovery document.

17. The article of claim 16, further comprising instructions that cause the machine to register agents in an agent directory.

18. The article of claim 17, wherein the instructions that cause the machine to receive discovery data comprise instructions that cause the machine to calling said two or more discovery agents from the agent directory.

19. The article of claim 17, wherein the instructions that cause the machine to aggregate said data comprise instructions that cause the machine to call two or more aggregator agents listed in an agent directory.

20. The article of claim 17, wherein the agent directory comprises a plurality of Extensible Markup Language (XML) files.

21. The article of claim 16, wherein the instructions that cause the machine to remove the second duplicate data entry comprise instructions that cause the machine to:
identify two or more agents responsible for generating the two or more duplicate data entries, each agent having a priority value;
compare the priority values of the two or more agents;
identify a first agent having a highest priority, said first agent responsible for generating a first duplicate data entry in the two or more duplicate data entries; and
remove all but the first duplicate date entry.

22. The article of claim 21, wherein the two or more agents are discovery agents.

23. The article of claim 21, wherein the two or more agents are aggregator agents.

24. The article of claim 16, wherein the discovery document is an Extensible Markup Language (XML) file.

25. The article of claim 16, wherein the instructions that cause the machine to receive discovery data comprise instructions that cause the machine to receive discovery data collected from two or more network device by said two or more discovery agents.

26. The article of claim 25, further comprising instructions that cause the machine to:
store the discovery document in a discovery database; and
generate a key for each discovered network device in the discovery document.

27. An article, including instructions residing on a machine-readable medium, the instructions causing a machine to:
register a first plurality of agents;
perform a first discovery operation including
collect and aggregating data from a first plurality of network devices with said first plurality of agents, and
coalesce said data in a discovery document;
register an additional agent; and
perform a second discovery operation with a second plurality of agents including said first plurality of agents and said additional agent.

28. The article of claim 27, wherein said first plurality of agents include a plurality of discovery agents and a plurality of aggregator agents.

29. The article of claim 28, wherein the instructions that cause the machine to register the additional agent comprise instructions that cause the machine to store an agent file describing attributes of the additional agent in an agent directory.

30. The article of claim 29, wherein the agent file comprises an Extensible Markup Language (XML) file.
